(19) United States
(12) Patent Application Publication
(10) Pub. No.: US 2007/0044639 A1
(43) Pub. Date: Mar. 1, 2007

(54) System and Method for Music Creation and Distribution Over Communications Network

(76) Inventors: Morwaread Mary Farbood, Cambridge, MA (US); Manasi Kulkarni, Burlington, MA (US); Joseph Presbrey, Cambridge, MA (US); Eric Zwick, Fort Myers, FL (US); Henry Kaufman, Cambridge, MA (US); Kevin Jennings, Lucan (IE); Ariane Martins, Cambridge, MA (US); Richard Resnick, Somerville, MA (US); Gary Griffin, Medford, MA (US); Robert Rainey, Cambridge, MA (US); David Newton, Brookline, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/456,739

(22) Filed: Jul. 11, 2006

Related U.S. Application Data
(60) Provisional application No. 60/698,562, filed on Jul. 11, 2005.

(51) Int. Cl. G10H 7/00; A63H 5/00; G04B 13/00

(52) U.S. Cl. 84/609

(57) ABSTRACT

A graphical music creation user interface is used to create and edit user compositions, which may then be transferred to a server and, through a cell phone carrier network, to cell phones or other portable devices. The compositions may be used as cell phone ring tones. Various graphical features allow for ease of music creation, while providing a possibility for fine-tuning created pieces.

### RELATED APPLICATION

This application claims the benefit of U.S. Provisional Application No. 60/698,562, filed on Jul. 11, 2005. The entire teachings of the above application are incorporated herein by reference.

### BACKGROUND

There are a number of software packages on the market that allow for music creation and modification on a personal computer. However, the majority of them are directed at experienced musicians who are familiar with music notation and can use them to create the pieces of music. There is a need for software that enables users with limited or no musical training to compose music without having to be familiar with musical notation and the details of music composition.

### SUMMARY

A graphical music creation software application may be used not only for creating music for playback on a computer, but also for creating music that is to be played back on other devices, such as, for example, cell phones. In one embodiment of the invention, users use graphical music creation software, such as, for example, Hyperscore, to create compositions that may be used as ring tones on cell phones. After a user creates a composition, the composition is transferred to a cell phone through a cell phone carrier network. In order for the composition to be used as a ring tone, it may need to be transformed into an appropriate file format, such as, for example, MP3 or an audio file.

In one embodiment of the invention, the transfer of songs from user computers to the cell phones may involve first transferring the compositions to a server housing the compositions, from which the compositions are sent to the cell phones. In an alternative embodiment of the invention, the compositions may be stored on the server for later use, such as, for example, sending a link to the composition to a friend, playing back the composition from a different computer, or sending it to additional devices. Another aspect of the invention may involve storing user-created compositions on the server and using them later to issue and sell music media, use in advertising, organize contests between users, etc.

In an alternative embodiment of the invention, user compositions may be available for download by other users in various formats, such as, for example, Hyperscore source file or audio file, whether for free or for a particular charge. In turn, users whose compositions are frequently downloaded may be rewarded either through monetary incentives or through discounts and public acknowledgment. A licensing scheme may be employed to obtain permission and copyright rights from users to use and sell their compositions.

In another aspect of the invention, there may be software packages implemented directly on portable electronic devices, such as cell phones or PDAs. These portable systems may be used to play back and even edit Hyperscore-created music compositions.

Accordingly, a method of distributing musical compositions comprises receiving, at a server, composition data representing musical compositions created using graphical music creation software; and transmitting, from the server to a user device, at least a portion of the composition data representing a selected musical composition.

Quality of speakers may differ significantly between the computer used to create a music composition and a portable device on which it will be played back. In order to facilitate better quality of music playback, one embodiment of the invention may offer users hints or assistance for creating compositions that will sound appropriately on the portable playback devices. To that end, a system may offer a playback feature, which allows the user to hear the composition as it will sound on a particular selected playback device. In an alternative embodiment of the invention, the system may suggest to the user that the particular frequencies may not be audible on the selected playback device. In yet another embodiment of the invention, the system may modify the composition itself, either automatically, or with input from the user, to sound better on the chosen playback device. These alterations may be done using the knowledge about various playback devices.

The previously available versions of Hyperscore have abstracted difficult parts of composing the music, but they have also been limited in the amount of freedom they allow to composers. One embodiment of the invention allows for conversion between the various musical representations, such as, for example, the Hyperscore graphical representation, a MIDI file, standard musical notation and piano roll notation into any other format chosen by the user. In such a way, a user may be able to create a composition using Hyperscore graphical interface, and then further edit it in another representation. Alternatively, a user may input a composition, including compositions by others, in a computer-recognizable file, and the graphical music composition software may convert it into Hyperscore graphical notation, so that the user may be able to edit this composition. One embodiment of the invention may employ artificial intelligence pattern matching algorithms in order to locate and extract motives within the usable composition inputted in a format different from the Hyperscore graphical format.

Another aspect of the invention enables users to edit Hyperscore compositions directly in the Hyperscore graphical interface with a great degree of freedom. For example, the user interface may be designed to permit editing and fine-tuning of various musical features, such as individual notes, chords, chord progressions, and/or keys. In such a way, a user may be able to create a composition using the Hyperscore interface, have the program adjust the music to sound more melodic, and then fine-tune the composition to the desired results.

Yet another aspect of the invention is directed to the program features used to create polyphonic motives. In a polyphonic motive, more than one pitch may sound, or more than one instrument may be employed, at the same time. These instruments may be of the same or different kinds, allowing the creation of multi-voice melodies and chords.

In one embodiment of the invention, a percussion motive is represented by various percussion instruments used together as part of a single motive, which is later used as a single motive in generating compositions through strokes. In particular, a percussion motive may be marked as a single color or line in the user interface.

The system may allow for the creation of an unlimited number of compositions and motives. To that end, an infinite color palette (color picker) may be used for creating colors to be used in lines drawn in the composition. A special kind of line may be used to represent musical sections that are not associated with any pattern. For example, a gray line may be used for such sections. In such a way, a song may be represented as a combination of multiple color lines representing multiple patterns and one or more gray lines representing musical sections that are not associated with any patterns. In inputting different representations of music and transforming them into Hyperscore format, one embodiment of the invention may also parse and define chord progressions in the inputted music. These chords could then be manipulated by the harmony functions in Hyperscore (either the line or some more precise mechanism).

Yet another aspect of the invention involves additional user interface details, such as, for example, global tempo line and/or global volume line. A global tempo line may allow for variable tempo for any section of the composition by drawing a tempo line. Similarly, a global volume line may allow for overall volume patterns, such as, for example, drawing a crescendo in one section of the composition.

In a graphical music creation environment in which notes are represented as elements in a graphical window along a temporal axis, a method of note duration resizing comprises selecting one or more note elements; clicking a selection handle associated with the selected note elements; dragging the handle along a direction parallel to the temporal axis; and releasing the handle when a desired duration for the selected note elements is reached along the temporal axis.

The graphical representation of resizing affords easy manipulation of note durations that are much more difficult to modify in traditional notation software.

In another aspect of the invention, a mouse or a mouse wheel may be used for resizing notes, continuously zooming, and clicking to focus attention on what the user wants zoomed. In an alternative embodiment of the invention, alternative input devices may be used for zooming and other musical controls, such as, for example, joysticks, touch pads, keyboards, floor pads, and other input devices available to one of skill in the art.

In another embodiment of the invention, a cell phone may be used to compose music by allowing the user to manipulate notes using buttons available on a cell phone key pad. In this embodiment, functions such as note selection, modification, sketch creation, and view zooming can be accomplished using the up/down/left/right and OK buttons available on most cell phones, as well as the numerical keypad available on all cell phones. Accordingly, apparatus on a cell phone for musical composition comprises a display that displays one or more melody windows and/or one or more sketch windows and a keypad having first keys for navigating among the windows and second keys for selecting and modifying elements within the windows to create and edit musical compositions.

In another aspect of the invention, the graphical strokes drawn in the Sketch Window are editable, allowing the user to control how motives repeat and sound in the musical composition. The graphical representation of the strokes allows for an easily edited display of motive repetitions, volume, pitch, and alignment with other motives, as well as other musical attributes. Strokes are easily edited through the use of direct manipulation tools found in standard drawing applications such as drawing, cutting, reshaping, pulling, smoothing. Wherever possible, the graphical modification has a clear musical interpretation.

A graphical music creation interface for defining a musical segment comprises a window having one or more measures and a temporal grid defining each measure with primary note divisions and each primary note division having secondary divisions, the window further having a pitch grid orthogonal to the temporal grid, the pitch grid having pitch divisions representing one or more note scales; and note elements for placing on the window grids.

In a graphical music creation environment, a method of musical composition comprises retrieving one or more musical composition motives from a music library, each musical composition motives representing a segment of music; and creating a musical composition using the retrieved musical composition motives. The user may use such libraries as the starting point for their own compositions, or may blend them together with their own compositions. Such pre-built libraries may include, for example, well-known melodies or good learning examples. These motive libraries may reside locally on the user's computer or may be downloaded on demand from an Internet-based interface.

Another aspect of the invention allows users to combine voice or other audio tracks with music composed using the graphical music composition software. In one embodiment of the invention, the voice is overlaid with the instrumental track in a computer music file format. In an alternative embodiment of the invention, the voice and/or the instrumental lines may be adjusted so as to harmonize better together.

Accordingly, a method of musical composition comprises assigning audio data to a musical composition motive; displaying a shaped stroke in a graphical composition window, the stroke mapped to the musical composition motive; segmenting the audio data into regions based on one or more audio features; and modulating the audio data by shifting the pitch of audio data in one or more regions based on position of the regions in corresponding portions of the stroke in the window. The audio features may include constant pitch, changing pitch, transients and non-pitched.

Yet in another embodiment of the invention, the harmony line feature can be expanded to encompass multiple graphical interfaces that allow users to display and manipulate the harmony in their music at different hierarchical levels. At the lowest level, users are able to edit individual notes for each chord in a piano-roll-like grid. At the highest level, users can manipulate the large-scale structure of the harmony with a broad graphical sketch. Harmony can also be applied to Motive Windows, not just a Sketch Window. When new motive-based material is sketched into a piece, its associated harmonic progression can be applied to it, overriding the default harmony applied to the Sketch Window. When lines overlap, the user can chose which progression should be applied for that time span—i.e. given several layers of harmony (multiple lines and their associated Motive harmonies as well as the default Sketch Window harmony), the user can choose from any of those to make active and in what order. Accordingly, a method of musical composition in a graphical music creation environment comprises representing harmony, key or harmonic progression in a temporal harmony region of a composition window; representing harmonic content of each harmony region including note structure that constrains the harmonic content in a harmonic content window; and representing notes in the composition as constrained by the harmony regions. The harmony regions may be modified based on shape of a harmony line in the composition window and/or based on manipulation of the region duration using graphical handles. The pitch and temporal positions of the note structure of the regions may be modified. The individual notes in the composition window may be modified to be outside the defined harmonic content.

As will be apparent to one of skill in the art, the graphical musical composition interface allows for a number of features and extensions not explicitly recited above.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram illustrating a network configuration for distributing musical compositions.

FIG. 2 is a flow chart illustrating a process for transferring a musical composition to a server for distribution to a cell phone.

FIG. 3 illustrates a graphical user interface for creation of musical compositions.

FIG. 4 illustrates the graphical user interface of FIG. 3 with motive windows and a sketch window.

FIG. 5 illustrates a portion of a sketch window in further detail.

FIG. 6 illustrates a polyphonic motive.

FIG. 7 illustrates a percussion motive.

FIGS. 8A-8D illustrate note resizing within a motive window.

FIG. 9 illustrates a motive library with preview.

FIGS. 10A and 10B illustrate a 3/4 time signature with grid settings.

FIGS. 11A and 11B illustrate a 4/4 time signature with grid settings.

FIG. 12 illustrates audio signal processing in a graphical music creation environment.

FIG. 13 illustrates a graphical user interface for music composition on a cell phone.

FIG. 14 illustrates hierarchical levels for controlling harmonic content in a graphical music creation environment.

FIG. 15 illustrates a homepage for a music space community.

FIG. 16 is a screen that illustrates a user upload dialog.

### DETAILED DESCRIPTION

A description of preferred embodiments of the invention follows.

A graphical interface that allows for easy creation and modification of musical pieces enables users of all abilities to generate their own music. Hyperscore is one example of such graphical music creation software. The embodiments of the invention described herein may be implemented not only in the Hyperscore environment, but in any other graphical music software, as deemed appropriate by one in the art.

Hyperscore, available from Harmony Line, Inc., provides a graphical computer-assisted interface for users with limited or no musical training and takes freehand drawing as input, letting users literally sketch their pieces. As a graphical environment that facilitates composition through intelligently mapping musical features to graphical abstractions, Hyperscore provides a visual analog for what is happening structurally in the music as opposed to displaying musical events in procedural notation or as a set of parameters, as is often the case with other graphical composition systems. The fundamental idea of Hyperscore is that anyone can perform two key creative activities without musical training: compose short melodies or ‘motives’ and describe the large-scale shape of a piece. Providing graphical means to engage in these two activities forms the basis for Hyperscore's functionality.

Hyperscore presents a unique graphical interface, which takes input in the form of freehand drawing. The strokes in the drawing are mapped to structural and gestural elements of the music, allowing the user to describe the large-scale structure of a piece visually. Hyperscore's graphical notation also enables the depiction of musical ideas on a detailed level. Additional annotations around a main curve indicate the placement and emphasis of selected motives. These motives are short musical fragments that are either composed by the user or selected from a set of pre-composed material. Changing qualitative aspects of the annotations, such as texture and shape, lets the user alter different musical parameters. Further aspects of Hyperscore are described in M. Farbood et al., “Hyperscore: A Graphical Sketchpad for Novice Composers,” Emerging Technologies, January/February 2004, pp. 50-54 and M. Farbood, “Hyperscore: A New Approach to Interactive, Computer-Generated Music,” Master's Thesis, MIT, September 2001.

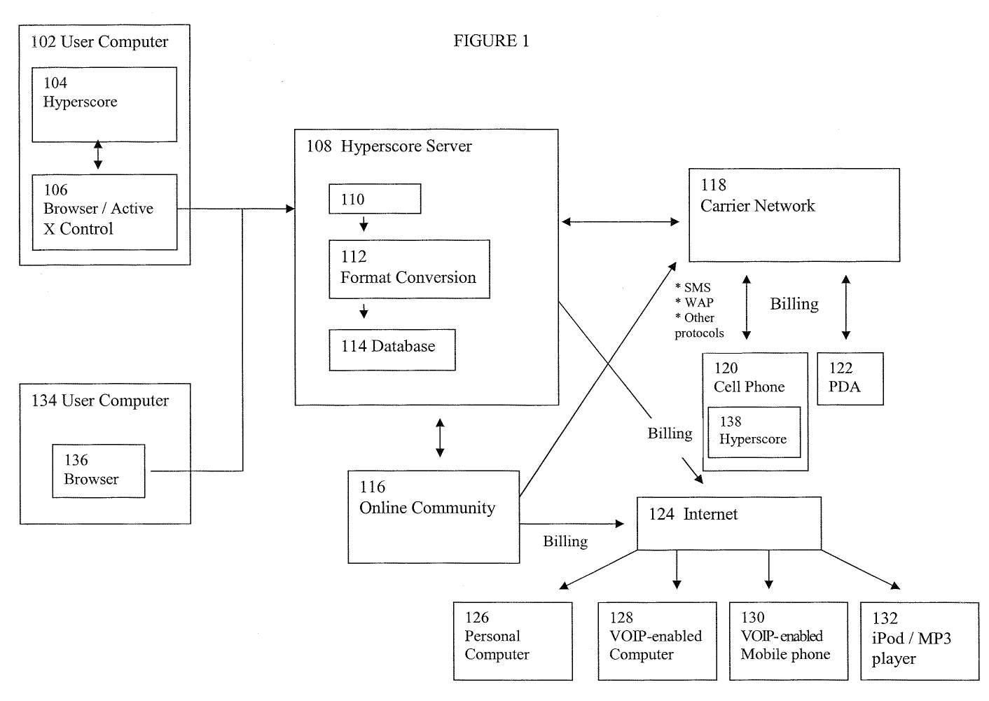

Hyperscore, or any other graphical music creation software, may be used to generate compositions, which may then be used in various applications, such as, for example, cell phone ring tones. FIG. 1 illustrates a system for creating musical compositions and transferring them to a server and/or to a cell phone or other devices for further use. The user creates his or her composition on a personal home computer 102 using Hyperscore application 104. The Hyperscore application may have a built-in ActiveX Browser 106, which is used to access Hyperscore's server 108. In an alternative embodiment of the invention, the browser 106 may be a stand-alone browser, and not part of Hyperscore. In an alternative embodiment of the invention, the browser 106 may be a combination of using web browser technologies and the base HTTP protocol to access Hyperscore's servers.

Using the browser 106, Hyperscore application 104 uploads music created by the user to the Hyperscore server 108. The Hyperscore server 108 may be simultaneously accessed by multiple users. In order to properly process all the requests, the requests may be temporarily stored in queue 110, from where they proceed through Format Conversion 112 to be into formats appropriate for online playback, and then stored in database or other storage system 114. The Hyperscore server 108 may perform various operations with the uploaded music, such as, for example, converting into various sound formats, modifying it, clipping it or storing it for further uses. From the Hyperscore server 108, musical pieces may be transferred to devices such as mobile phones 120 and PDAs 122 through a carrier network 118, or to devices such as personal computers 126, personal computers with VOIP applications 128, VOIP-enabled mobile phones 130, or MP3 players 132 through the Internet 124, using standard protocols. Regardless of whether the transfer occurs over the cell phone carrier network 118 or the Internet 124, standard interfaces, such as WAP, XML or SOAP interfaces, may be employed in order for the Hyperscore server 108 to transfer the music to the appropriate devices 120, 122, 126, 128, 130, and 132. Hyperscore server 108 may itself be a collection of multiple servers, either physically or logically.

In order to generate revenue, users may be charged for either the ability to transfer music to or from the server 108 from or to their computers or for the ability to transfer or use the music on target devices 120, 122, 126, 128, 130 and 132. Various billing schemes may be implemented, as deemed appropriate by one of skill in the art. In one embodiment of the invention, users may be charged by an application residing on the Hyperscore server 108 after the upload. In an alternative embodiment of the invention, the carrier networks may be responsible for charging individual users, accumulating the amounts and transferring them to the company running the Hyperscore server on a predetermined basis.

In addition to transferring the music to the cell phones or other portable information devices, the Hyperscore server may be used for various other applications, such as, for example, sending music to other users. In order to send music to someone else, a user on a computer 102 may click the option “send to a friend”, at which point the program will upload the music to the Hyperscore server 108 in the background, and will later transmit it to the indicated user 134 through email or any other networking means. In an alternative embodiment of the invention, the music is not transferred to the second user. Instead, a link is sent, and the user may choose to retrieve the music from the link. In yet another embodiment of the invention, there may be implemented a web version of Hyperscore, which users may access and use to play and modify music located on the Hyperscore server 108. In an alternative embodiment of the invention, users may be able to transfer music from the User Computer 134 directly to the Hyperscore Server 108 via a Browser 136 without the use of Hyperscore 104 whatsoever. In yet another embodiment of the invention, other users may access the Database 114 of music available on the Hyperscore Server through Online Community 116 and thereby preview and purchase music created and uploaded to the Hyperscore Server 108 by other music composers/authors and users.

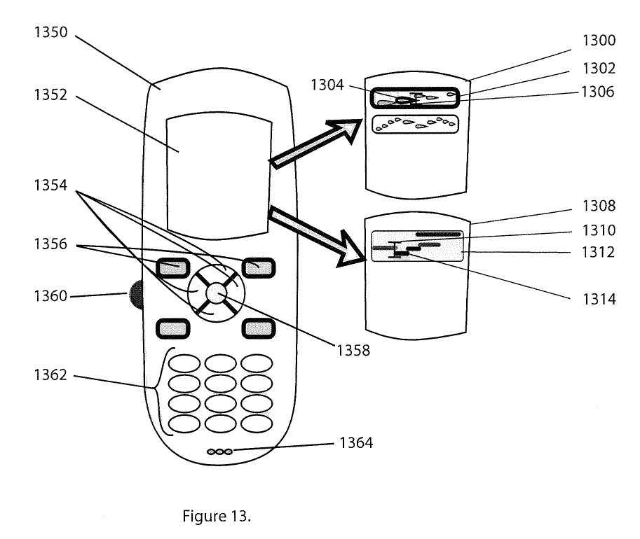

In another embodiment of the invention, the cell phone 120 may include Hyperscore application 138 which provides a graphical music creation environment for creating musical compositions directly on the cell phone. Details of an embodiment of the graphical user interface are described further herein in connection with FIG. 13.

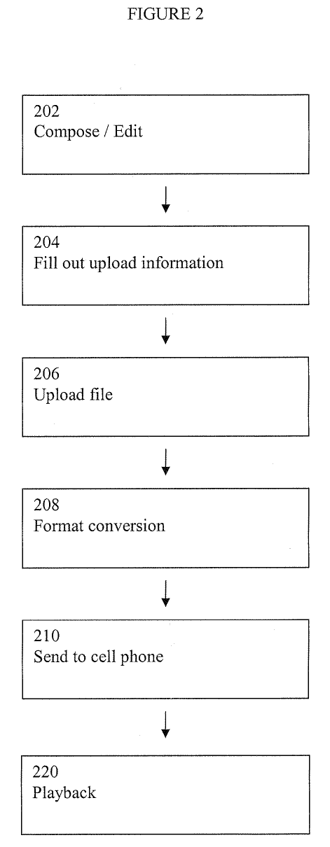

Illustrated in FIG. 2 is a process of uploading music to a cell phone. In step 202, users compose or edit their musical compositions. In step 204, a user selects the option of uploading the music to the cell phone and fills out a form with appropriate parameters, specifying, for example, the type of cell phone or the cell phone number and/or cell phone carrier network, the user' identification information, and/or billing information, etc.

While the user is filling out the form, or it is pre-filled automatically, the music may be simultaneously uploaded to Hyperscore server 108 (step 206). Uploading the music in the background, while the user is filling out the requisite form fields, allows for faster perceived transfer on a slow network connection and general convenience to the users. However, in an alternative embodiment of the invention, the upload process may be delayed until the user explicitly authorizes it.

When the music is uploaded to the server, it may be converted to an appropriate format in step 208. Such a format may be, for example, an MP3 file or an audio .wav file. When the conversion is complete, if it is necessary, the composition may be sent to a target device 120, 122, 126, 128, 130, or 132 via carrier network 118 or the Internet 124 (step 210), after which it may be played back on the target device and used as a ring tone (step 220). In an alternative embodiment of the invention, the format conversion (step 208) enables users to share their uploaded music with other users accessing the Online Community 116, who may then decide to download the music themselves stepping into the process at step 210. In an alternative embodiment of the invention, the conversion between the various music file formats takes place on the user computer 102, and the server requests appropriate formats for the upload, so as to minimize the network transfer times and reduce computation at the Hyperscore Server 108. In an alternative embodiment of the invention, the steps of uploading the music to the server may be skipped and the music may be sent directly to the cell phone through the cell phone carrier network, using appropriate interfaces in the Hyperscore program itself. In yet another embodiment of the invention, there may be billing information that needs to be entered before the music is sent to the cell phone.

Because of the differences in speakers and other hardware available for music playback, there may significant differences in the quality of sound of the composed music on the computer on which it was composed and on the device on which it will be played back. In order to facilitate the creation of music that may sound good on the playback devices, Hyperscore may employ the user interface for suggesting to the user which frequencies or instruments sound better on the particular playback device selected by the user. Such information may be retrieved from a playback device database.

In an alternative embodiment of the invention, the graphical musical application may automatically modify the music to sound better on the particular playback device by, for example, passing it through filter or modifying some musical parameters. In yet another embodiment of the invention, the application or the server may provide the functionality of playing back the music on a computer while imitating the sound as it will sound on the chosen playback device. For example, the user may be presented with the option of playing back the song as it will sound on the user's cell phone. By previewing the songs on the personal computer, the user may avoid uploading multiple compositions in order to achieve the desired sound. The appropriate quality of playback may be achieved by passing the song through a filter, for example, filtering out the low bass lines which generally sound poorly on the low-powered speakers of a cell phone.

The embodiments described herein include features that are improvements over prior versions of Hyperscore. These improvements include polyphonic motives, percussive motives, note resizing, temporal gridding, music motive library, audio signal processing, graphical user interface on a cell phone and hierarchical levels for controlling harmonic content.

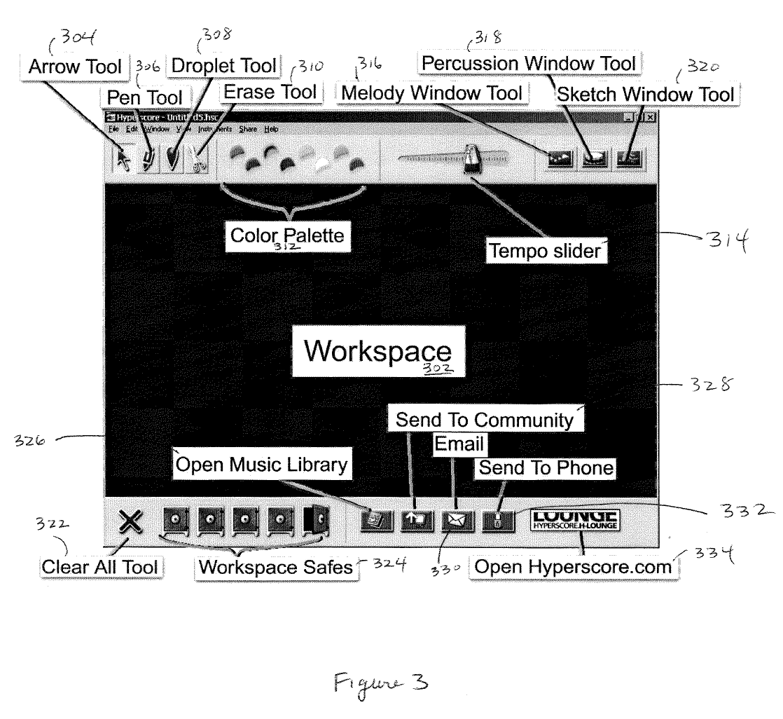

FIG. 3 illustrates the graphical user interface for an embodiment of Hyperscore with various function buttons for creating compositions in workspace 302. In the upper left corner of the graphical user interface are drawing tools that include arrow tool 304, pen tool 306, droplet tool 308 and erase tool 310. To the right of the drawing tools is a color palette 312 and a tempo slider 314. In the upper right corner are three window buttons: melody window tool 316, percussion window tool 318 and sketch window tool 320.

The arrow tool 304 is used for selecting a graphical item in the workspace 302 for editing. The pen tool 306 is used to draw colored lines in a sketch window. The droplet tool 308 is used to add droplets in a melody, polyphonic or percussion window to create a motive.

At the bottom of the graphical user interface are the following function buttons: clear all tool 322, workspace safes 324, open music library 326, send to community 328, email 330, send to phone 332 and open Hyperscore.com 334.

The clear all tool 322 clears graphical items from the workspace 302. The workspace safes 324 are for selecting among workspaces. The open music library button 326 is for selecting motives from a library of motives. The send to community button 328 allows the user to send a composition to an online community described further herein. The email button 330 allows the user to send a composition as an email attachment or as a web link in an email. The send to phone button 332 allows the user to send a composition to a cell phone or PDA. The open Hyperscore.com button 334 is a shortcut to a website for accessing Hyperscore-related content.

The workspace 302 is an expansive, zoomable canvas in which users can create any number of musical fragments or motives and whole pieces. The first step in composing a piece is to create the musical fragments or motives in the motive windows. The windows' horizontal axis represents time, and the vertical axis represents pitch (spanning two octaves). Users can stretch or shorten the window to modify the motive's duration. Colored droplets represent notes, and users add them by clicking on the grid. The system interprets blank spaces as rests.

The second step is to create whole pieces in the sketch window by drawing colored lines, which are mapped to the colors of the melodic/rhythmic material in the motive windows. Hyperscore's algorithms intelligently map these “motivic” patterns to the position and contour of the lines in the sketch window.

FIG. 4 illustrates several example motive windows 402A, 402B, 402C, 402D, 404, 408A, 408B, 408C and sketch window 406 with strokes or lines 410A, 410B, 410C, 410D, 410E, 410F, 410G, 410H representing the motives above or below a central harmony line 412. Motives 408A, 408B, 408C are examples of melody motives. Motives 402A, 402B, 402C, 402D are percussive motives, and motive 404 is a polyphonic motive, each of which is described further herein.

Each motive is assigned a color 403 selected from the color palette 312. In the example, the mapping from the motive windows to the sketch window is as follows: (402A, 410B); (402B, 410C); (402C, 410H); (402D, 410E); (404, 410F); (408A, 420D); (408B, 410G); (408C, 410A).

Hyperscore addresses harmony in a number of different ways. In the simplest example, single chords may be inserted directly without a reference point and without regard to what precedes or follows them. Users can add individual chords consisting of three simultaneous voices to the sketch window. They are displayed as colored droplets, with each color representing a different harmony type: major, minor, augmented, diminished, and so forth.

Defining transitions from one chord to another is the first step toward adding functional harmony. This can be as insignificant as the prolongation of a previous chord or harmonic function or as far-reaching as a move to a new key. The Hyperscore graphical user interface enables users to describe these types of harmonic progressions by shaping the central harmony line. Depending on whether the curves in the central line are going up or down and depending on their shape, the program chooses relevant chords.

Users can choose from between three harmony styles: none; general (or diatonic, where all chromatic pitches are changed into diatonic pitches); classic (or major/minor, tonal harmony based on Bach-style harmonization). One of the principle advantages of having a graphical notation system in the form of freehand drawing is that it provides the user with an expressive means of shaping musical direction. Drawing a contour is a simple and intuitive way to depict areas of harmonic tension and resolution. The harmony line that runs through the center of each sketch window can control major/minor and diatonic harmony types.

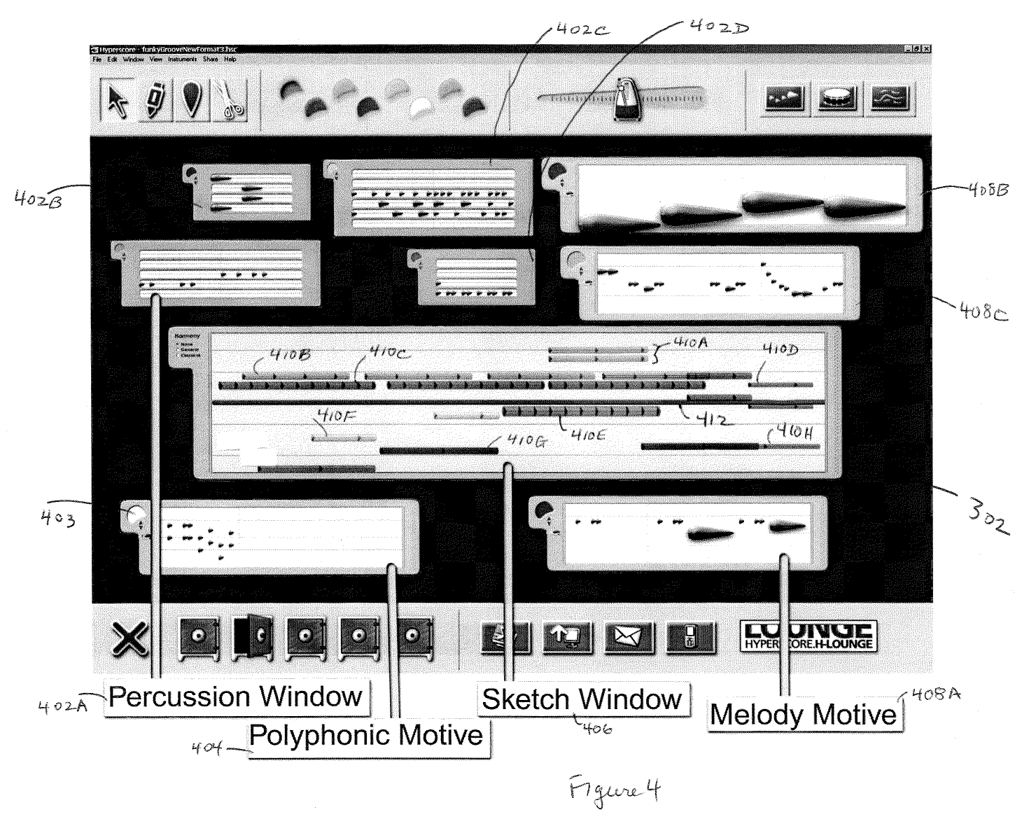

FIG. 5 illustrates a sketch window 502 in further detail. The harmony mode 504 allows the user to select the harmony type (none, general classical). In the horizontal direction one measure 506 is marked. A pitch transposition grid 508 is shown marking every semitone. The motive strokes in the sketch window of FIG. 4 are shown only as straight lines, referred to as constrained strokes 512. A freehand stroke 510 may also be used. Motive repetitions 514 are marked by arrows. A harmonic region 516 is shown as the curved section of harmony line 518.

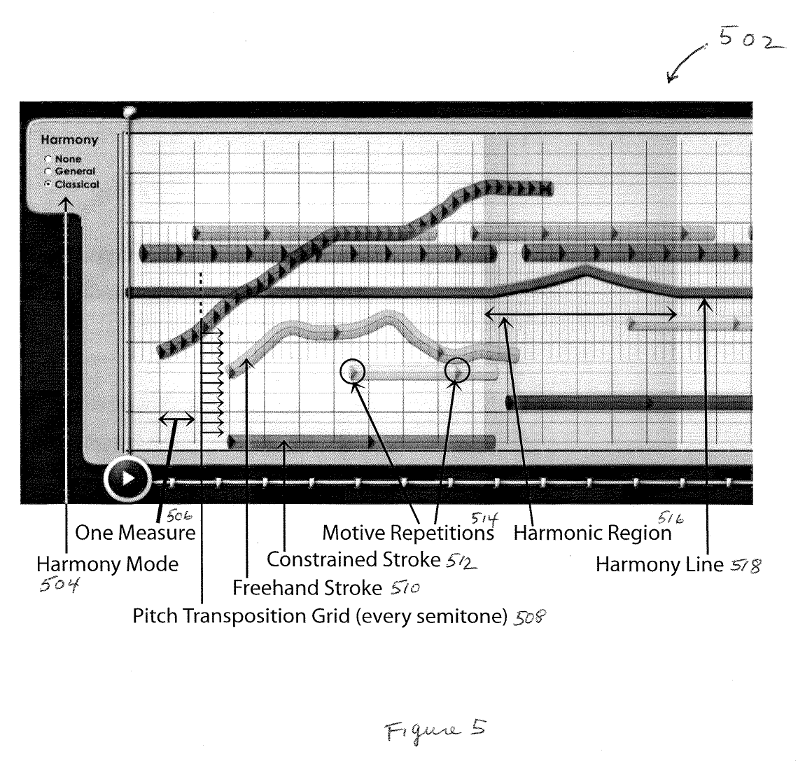

In one aspect, the motives need not be restricted to one instrument. While melodies encapsulate various instruments, among which are instruments like the saxophone, which can only play one note at a time, in one embodiment of the invention, it is possible to create a polyphonic motive as shown in the polyphonic motive 404 of FIG. 4. A polyphonic motive takes away the constraint of only one note being played at a time. This aspect can be seen in the detailed view of polyphonic motive 602 shown in FIG. 6. Without polyphonic motives, it may be cumbersome to implement certain sounds, such as, for example, from a drum set, where six instruments may play at the same time. These six instruments could be recreated using separate motive windows, but it is very cumbersome to do so. In one embodiment of the invention, it is easy to create drum tracks using percussion motives where each track is only one sound and is not pitched. Examples of percussion motives are the motives 402A, 402B, 402C, 402D shown in FIG. 4. A more detailed view of a percussion motive 702 is shown in FIG. 7. A percussion motive includes multiple tracks 704, 706, 708, 710, 712, with only one note position for each track. Using these tracks, it is easy to build up multi-track percussive motives and assign a color to them. If a user draws in the assigned color, the result is a percussion line, including all the instruments in that percussive motive. Percussion line is one example of a polyphonic motive, because notes are not constrained to one at a time.

It is also possible to create polyphonic motives of a single multi-pitched instrument, such as a piano. In a melody motive, a user can simply enable polyphonic mode, and then the single-note constraint is removed. This allows a user to compose with chords, arpeggios, and other multi-note musical forms. The interface does not limit polyphonic mode to actual polyphonic instruments. For example, it is possible to create polyphonic music with a Saxophone, which could simulate a group of Saxophone players.

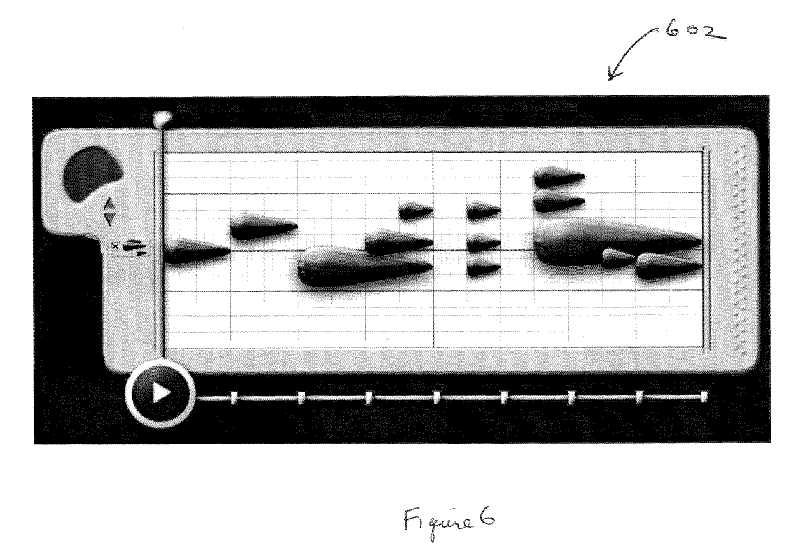

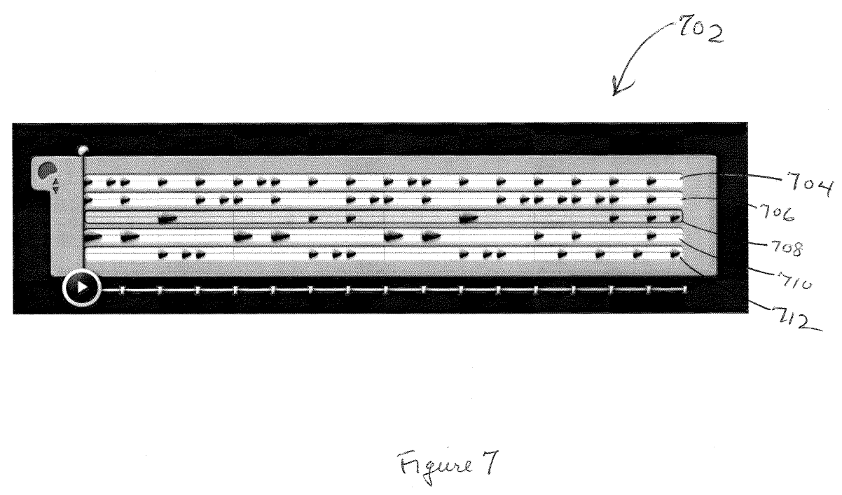

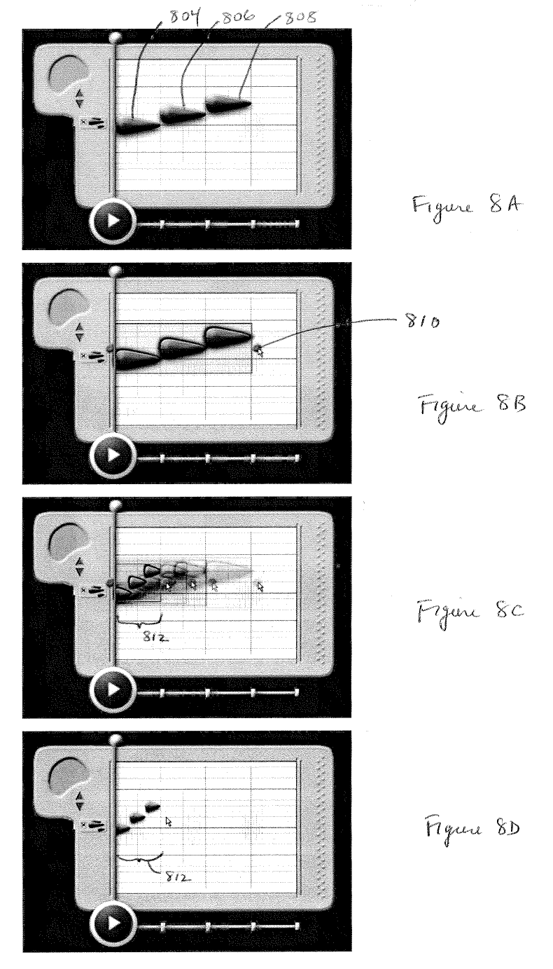

Another aspect of the graphical user interface of one embodiment of the invention is directed to graphical note resizing. Using graphical note resizing, the user may resize the temporal length of the note. The graphical representation of resizing affords easy manipulation of note durations that are much more difficult to modify in traditional notation software. For example, in creating note tuplets, where the there are several notes in the space of one note, other software composing tools require cumbersome specification of how many notes are in the tuplet, etc. In the present approach using improvements to Hyperscore, a three-note tuplet is easily created simply by selected three notes and resizing the group until the whole selected group is the size of the desired duration (e.g., a quarter-note, or a half-note). Because the end points of a selection are constrained to stay on the grid, the tuplet and individual note durations are represented exactly (to the floating point resolution of the computer). The steps in forming a three-note tuplet are as follows and shown in FIGS. 8A-8D, 1) select three adjacent notes 804, 806, 808 of equal duration (FIG. 8A); 2) resize the selection by clicking on one of the selection handles 810 (FIG. 8B); 3) drag the handle (FIG. 8C) until the selection is of the desired duration 812 (note that the whole selection duration is continually snapped to the nearest time grid line during this process); and 4) release the mouse button when the desired duration has been reached (FIG. 8D). Note that other more complex tuplets with uneven note durations and rests can be formed in a similar manner.

Generally, composing is facilitated by constraining note onsets and durations to a temporal grid (e.g., quarter notes), but there are cases where the grid constraint must be relaxed or adjusted. Such is the case with resizing collections of notes because the note onsets and durations may not lie on the temporal grid after the resize operation. The multiple note element resizing may be facilitated by constraining the endpoints of the selected note collection to the temporal grid. If the handle at end of the selection is manipulated, the ending of the collection of notes is optionally guaranteed to lie on a temporal grid line. If the handle at the beginning of the collection of notes is manipulated, then the beginning of the collection is optionally guaranteed to start on a temporal grid line. All the notes within the selected note collection are scaled by the ratio between the final duration and the original duration of the note collection. Thus, after scaling, some note durations and onsets may not reside on the grid (even when the beginning and ending points of the note collection are constrained to the grid). Often this will be the desired outcome. For example when creating tuplets, exactly constraining the beginning and end points of the selected note group allows the creation of an exact tuplet because the note group is guaranteed to reside in a musically defined temporal period (e.g. one half note).

In another aspect of the invention, an additional computation pass may be performed to snap the note onsets and durations to the temporal grid. This could occur depending on a user's preference setting indicating that all selected notes' onsets and durations should remain on the temporal grid.

The graphical user interface also may include add-ons phrasing for things like styles and also may use y-coordinate for volume and have vertical sliders on each note to change the volume on each note. In yet another embodiment of the invention, there may be a pitch bend line for modifying the pitch of the motive. A smoothly interpolated pitch bend could also be used when a user graphically bends a single note to smoothly change the pitch, as is possible on a Trombone.

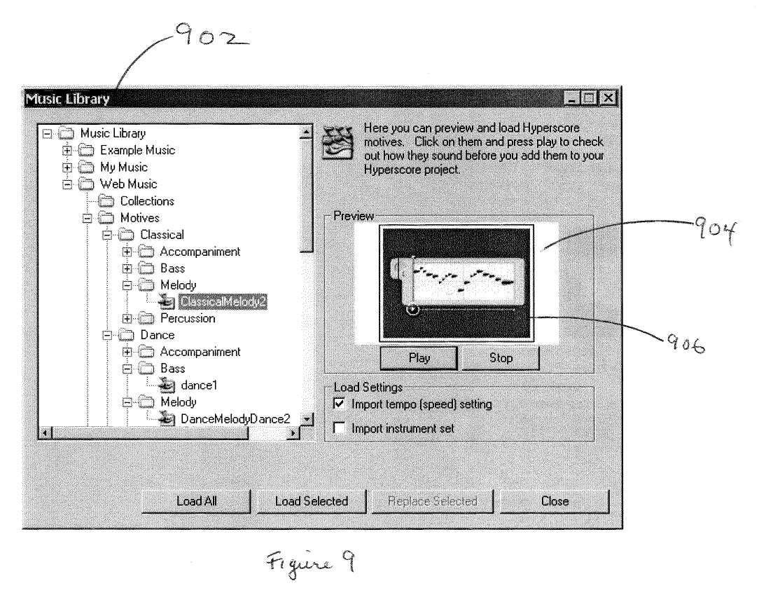

In order to facilitate creating music compositions, an embodiment of the Hyperscore software may provide a dynamic motive library that allows for easy music creation and sharing of elements and premixing. As shown in FIG. 9, the user can browse and access the example compositions from the motive library 902 in a special motive library viewer 904 which allows the user to preview a selected motive 906. The user is able to import the selected motive into the current editing session where it can be incorporated and mixed into a more complex piece of music. The motive library is different from standard mixers in the music sketch approach. In particular, rather than users simply taking a pre-exiting segment of music and mixing it, the motive library allows users to draw it so that they can change a pitch, change a key, or do any other kind of musical modification before or after mixing it with other pieces.

In the motive library viewer 904, the user may browse through a hierarchy of music groupings, where some of the information may reside on the user's computer, and some may reside on a web server and is dynamically downloaded when selected by the user. The downloaded music files are cached on the user's computer in a manner similar to a web browser in order to speed up reaccessing the same music files. The local vs. web access of music files happens transparently to the user. Global parameters such as tempo can be optionally imported from the motive library files as well. The motive library is dynamic in that the users may create their own motive libraries and upload them to the server, from where they may be downloaded by other users. The original creators of the motive library may be compensated through discounts or even monetary compensation if their motive libraries are popular. Users may yet be able to vote for the motive libraries they like or it is possible to have voting competitions for single motives or entire compositions.

In order to facilitate music creation, one embodiment of the invention may allow for music to be converted between various notation formats, such as, for example, between various music notations and between different computer file formats. Such music notation includes standard music notation, piano roll notation, chord notation, and any other notation known to one of skill in the art. The musical file formats include MIDI, MP3, Hyperscore graphical format, audio files, and other formats known to one of skill in the art. In order to convert music from various formats into the Hyperscore graphical format, Hyperscore may include an artificial intelligence module that may choose different tracks and motives from the selected file.

The graphical music interface may allow for direct note editing, such as, for example, zooming into the lines and injecting individual notes to have a fine level of control over the output music while still allowing ease of use of the broad gestures. In Hyperscore, there is not necessarily a one-to-one mapping between the stroke and the musical output—that is, there may be smaller details that may be ignored—however, in one embodiment of the invention, it is possible to add gridding to the display to allow the users to see how things are represented visually, so that users can see how far they need to move a line up or down to hear the difference. Temporal gridding parameters allow the user to control time signature as well as the precision of note or stroke alignment and snapping.

In an alternative embodiment of the invention, changes in the drawings of the curve may be parsed into control points, and those control points may indicate where the note or the key will be changed, providing users with feedback and the ability to grab those points and change the notes. In such a way, the Hyperscore graphically and intuitively lets the user control the music with more precision. Furthermore, standard drawing application tools (such as reshaping, cutting, and transforming) may be used to edit the lines to reshape the curve in order to change the sound or the motives in the composition.

In an alternative embodiment of the invention, various visual attributes of the draw curves map to musical attributes of the composition. Attributes include the texture, thickness, transparency, and additional features drawn on the line such as markers to indicate motive repetitions, and even individual note positions. The visual attributes both display the state of the music composition and allow direct manipulation of those attributes through various graphical tools.

In yet another alternative embodiment of the invention, the Hyperscore software may make decisions as to where it can modulate music up or down and display the notes drawn in comparison to the curve, but allow users the ability to change the modulation and zoom in on a particular note. A change in one note may not necessarily change the way the curve looks, but the software may remember the change, so that if the curve is pulled up or down, the note may be changed accordingly.

In yet another alternative embodiment of the invention, the Hyperscore music may be converted into a giant piano roll notation and the users may be able to see every note that is generated exactly as it is and may be allowed to modify those notes. Furthermore, the piano roll notation and the graphical interface may be shown side-by-side, such that if the user moves one curve, the piano roll notation is modified as well to move the notes and those notes may be tagged as specifically hand-adjusted notes, which the user can choose to keep as hand-adjusted notes, or let them go back to being automatically adjusted ones. In yet another embodiment of the invention, the key, the chords, the chord names, the notes and/or note names may be explicitly displayed and modified by the user.

A more flexible vertical gridding allows for further ease in modifying the music, so that the gridding may represent not only equal space half tones, but may also be shown as, for example, a grid in C major, so that the notes are not equally spaced. A user may be able to snap to various modes and adjust gridding correspondingly. In another embodiment, the pitch snapping may not be limited to notes in the scale or harmony, but visual feedback may be given to the user highlighting notes that may be out of the scale or harmony.

The user may define arbitrary temporal grids in order to impose limits on note duration and alignment as well as to define musical time signatures. The user works with the concept of a musical measure containing N primary notes of M duration, where M is the denominator of standard note duration (e.g., “4” for quarter note). The time signature N/M corresponds to a standard definition of musical time signature (e.g., 3/4 means three quarter notes per measure). This concept is made more general in the present approach by allowing the user to then define further subdivisions of each primary note. For example, the measure can be divided into twelve units that are defined as four quarter notes divided into triplets. This type of division is useful in certain genres of music, for example Jazz, and Afro-Cuban music. Furthermore, the user can decide how many further recursive subdivisions are required beyond the primary note duration in order to make shorter notes and have more precise positioning. Each further subdivision divides each grid space in two, so another subdivision allows for twice the precision (e.g., from eighth note to sixteenth note precision). The visual grid display and functional note snapping are automatically updated when the user changes the temporal grid parameters.

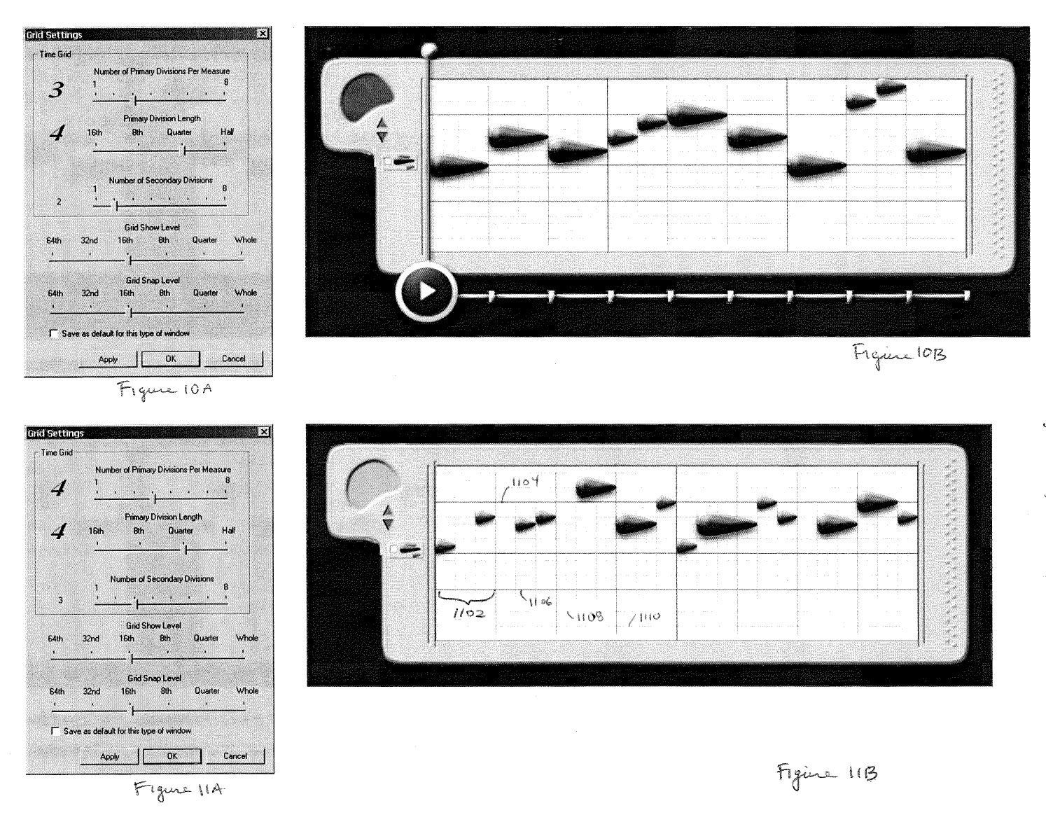

FIGS. 10A and 10B show one example of a 3/4 time signature with grid settings. FIGS. 11A and 11B show an example of 4/4 time signature with grid settings, where each beat (quarter note) 1102 is divided into 3.

In addition to temporal gridding, a pitch grid shows which pitches are in the current scale. Several levels of highlighting are shown 1104, 1106, 1108, 1110. Pitches that are at the tonic of the scale (e.g., C for a C major scale), are highlighted the most, followed by a fifth above the tonic, followed by the rest of the notes in the scale, and finally the rest of the chromatic notes.

In another embodiment of the invention, notes may be constrained to only lie in the scale, or within a subset of notes in the scale as defined by a chord. In another embodiment of the invention, notes may highlight differently if they are in the scale or harmony versus outside of the harmony. The difference between constraining the notes versus highlighting is that constraining allows novice users to place notes without worrying about making atonal music, whereas the highlighting would permit experts to make “out-of-harmony” notes deliberately, while graphically being notified of the choice to make an “out-of-harmony” note.

In yet another embodiment of the invention, addition effects may be presented, such as, for example, reverberation or other auditory effects, which may be also graphically displayed.

In one embodiment of the invention, the content of an audio file may be used as one pattern and may be mixed into different melodies. In an alternative embodiment of the invention, the whole file may be treated like a sound file and may be played back without pitch modulation, mixing it with the composed music. In yet another embodiment of the invention, a single line-stroke window may be created for playing the particular file.

In a more complex embodiment of the invention, the audio file may be treated as a motive and may be drawn on the composition window where it may be repeated and modulated. In yet another embodiment of the invention, pitch bending and digital signal processing may be employed, controlling the pitch of the playback.

In yet another embodiment of the invention, the short audio file may be treated as a single note and used in the motive, for example, in the percussion motive. In yet another embodiment of the invention, it may be possible to build up the MIDI sound font, where the users may specify an instrument, pitch and velocity (loudness) and the music synthesizer on the PC may convert that to the actual sound by having a sound library for each instrument. Users may be enabled to add new types of instruments by adding new sound site samples, called sound fonts.

Computer MIDI files typically already contain note information, and so they may be divided into different tracks by instrument. They may then be modulated up and down. In one embodiment of the invention, MIDI files may be parsed into motives and lines may be drawn that refer to those motives. Such parsing may be done by looking for repeated elements and parsing those as motives. What makes up a motive is defined by temporal relationships of the notes, but the parsing module may also control for the overall pitch and tempo. The portions of the music that do not fall into the parsed motives may be represented as a gray line—an unmotivic section of the music. In an alternative embodiment of the invention, a similar type of parsing may be applied to the standard scores or chord notation or piano roll notation.

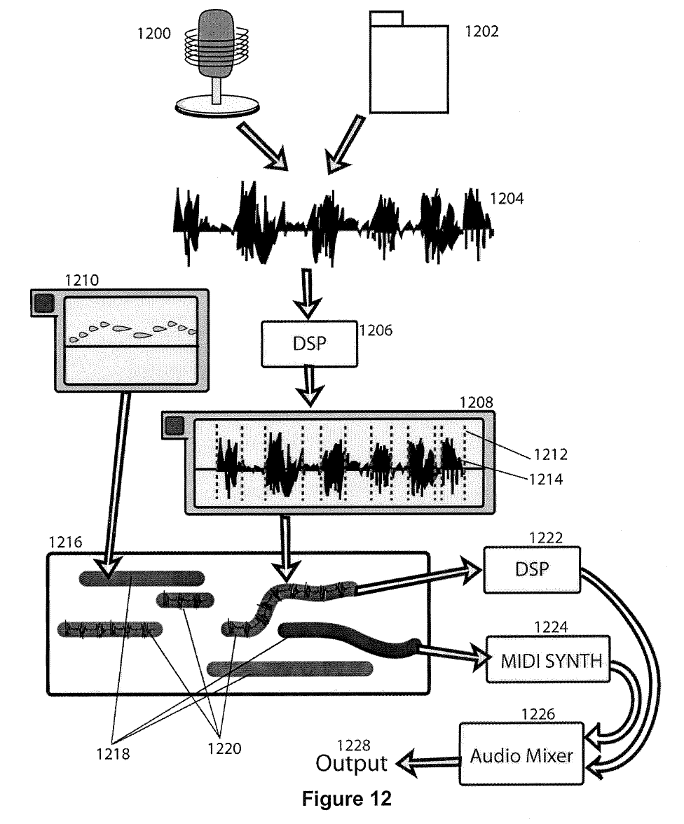

In another aspect of the invention, audio processing (digital signal processing) such as signal segmentation and pitch shifting may be used to modify pitches in the audio stream in order to make the audio follow the position and direction of the line drawing in the sketch window. The audio processing can also be used to improve the tonal quality of the sound by modifying audio pitches so that they are exactly in the current key or harmony of the given section in the sketch window. An embodiment of this feature is illustrated in FIG. 12. In connection with this feature, audio data originating from a microphone 1200 or an audio data file 1202 may be stored in memory 1204 in the composing application, e.g., Hyperscore application 108 or 138 (FIG. 1). The raw audio is then processed via digital signal processing 1206 to segment the audio signal into regions of constant pitch, changing pitch, transients, non-pitched or other audio features. The segmented audio signal is displayed 1214 in the application as an Audio Window 1208, with the segmentation 1212 optionally displayed as well.

The application also may show MIDI-based windows 1210 and the user may combine musical material from either type of source window in the Sketch Window 1216. Lines that originate from audio material 1220 show some aspect of the audio signal, while lines that originate from MIDI or non-audio material 1218 do not show audio signals.

Individual segments in the audio data may be pitch-shifted with further digital signal processing 1222 (either up or down) independently by varying amounts in order to account for the vertical position of the audio strokes 1220, the shape of audio strokes, and or the harmonic content of the composition (as defined by the Harmony Line or other features in the user interface).

In an alternative embodiment, the modulated audio data may be combined with the output of a software MIDI synthesizer 1224 and combined in an software audio mixer 1226 and finally either output 1228 to speakers or to a possibly compressed data file. The data file may either be saved to local computer storage disk or uploaded to a server for sharing or sending to a phone as described herein.

In another embodiment of the music composition tool, the graphic user interface may be adapted to function on a cell phone. FIG. 13 illustrates cell phone 1350 with a display 1352 used to show and edit the music composition. Because standard cell phone displays are typically of lower resolution in pixels compared to desktop personal computer displays, the interface may be simplified to show part of the composition at any given time. For example, the display 1352 may show only Melody Windows 1300, or Sketch Windows 1308. The user may navigate between windows using the up/down/left/right buttons 1354 on a standard cell phone button pad, and select with the OK button 1358. The selected window highlights visually 1302, at which point the same navigation buttons 1354 function to navigate within the notes or strokes of the selected window. A visual cursor 1306, 1310 may aid the user to show what can be selected, the individual notes 1304 or strokes 1314 can visually highlight as well. Once a note or sketch is selected, it can be manipulated with the navigation keys 1354, or the numeric pad, 1362. Other keys 1356 may be used to move up and down the selection hierarchy (e.g., general window selection to specific note or stroke selection), as well as visually zoom in and out. Some phones have a roller wheel on the side of the phone 1360 that may be used for the zooming function.

In another embodiment of the invention, the microphone in the cell phone 1364 may be used as an audio input device that can record voice to be incorporated into a music composition. The voice data may be sent to a server for further manipulation and insertion into other compositions.

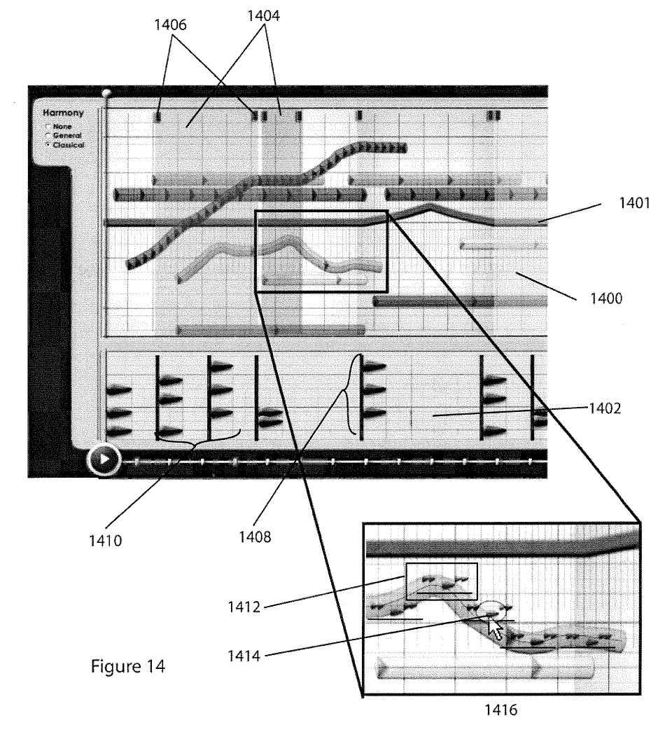

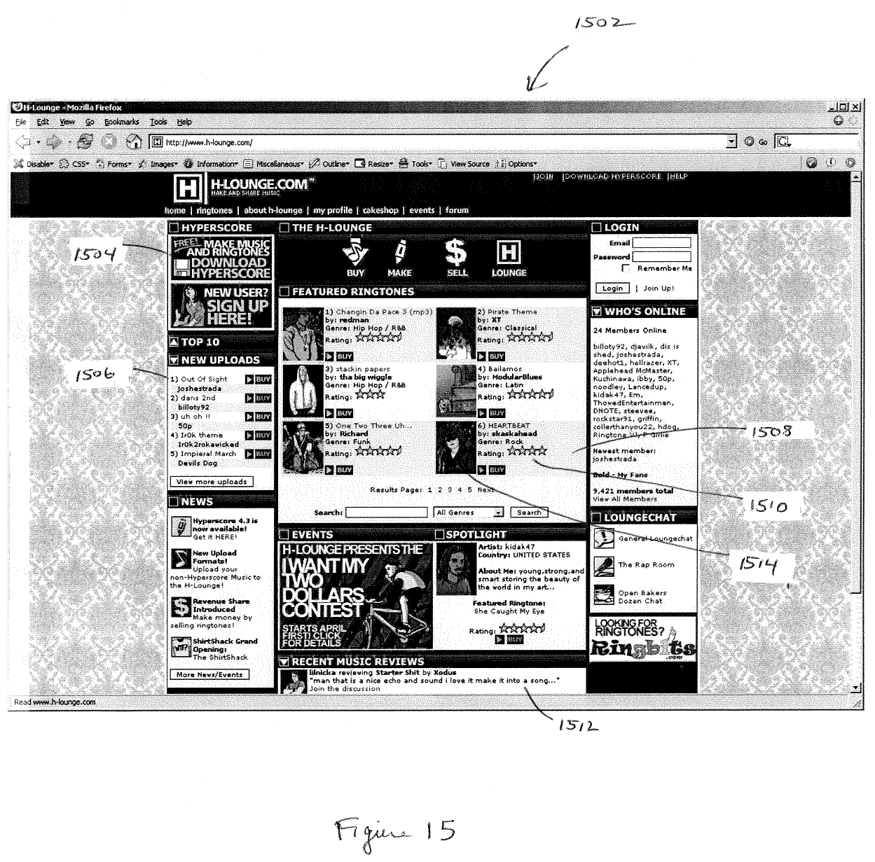

The levels of editing the harmonic content of a composition are shown in FIG. 14. At the highest level, the details of the harmony representation are visually hidden from the user because the user only sees and manipulates graphical regions that represent harmonic or key and/or harmonic progression in a bounded temporal region of the composition in the sketch window 1400. Harmony regions 1404 can be modified symbolically by drawing different forms in the harmony line 1401 that are automatically recognized such as sharp points or round regions. Harmony regions 1404 can also be manipulated directly by selecting region types from a list of possible harmony region types and adding them and by removing regions. Harmony region boundaries may also be moved and stretched in time by the use of visual handles 1406. At the next detail level, the chord or key notes that each region is constrained to are visualized and are changeable in a harmonic content window 1402. The visualization is similar to the melody window, except that the notes all represent the chord 1408, chord progression 1410 or key that the melodic material should he constrained to (rather than actual melodic content). The notes in the harmonic content window 1402 are visible in a single octave, but are implicitly repeated to all octaves above and below the visible octave. If a note is modified in this visualization, the melodic content in the sketch window 1400 is updated to stay within the constrained set of notes that are visible in the given region.

At the finest level of editing detail 1416, the melodic content of the melody window associated with a stroke is shown as it has been modified by the stroke shape and harmony description, and its repetitions across the stroke 1412. The notes that are visible at this level are directly modifiable 1414, in such a way as to override the automatically selected notes from the harmony algorithm and stroke shape modulations.

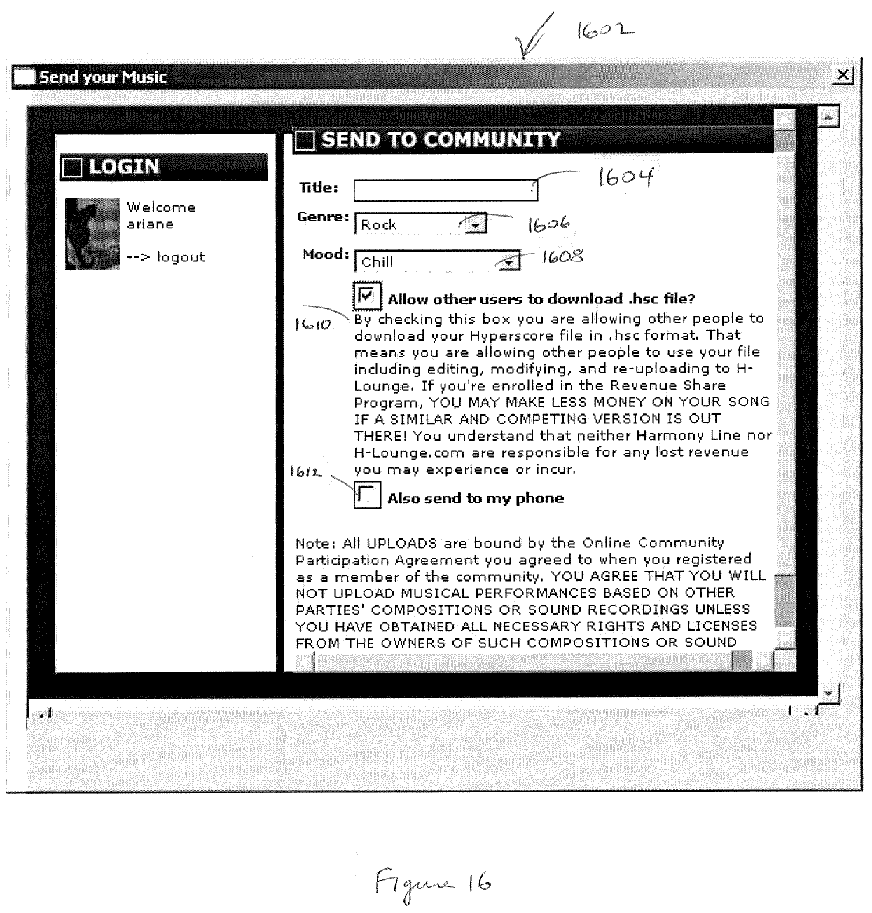

Yet in another embodiment of the invention, a notion of a browser-based Hyperscore music space community may be created, where users can upload, share, download, rate, review or collaborate on each other's compositions. Furthermore, user's compositions may be available for download from such music community by other users in various formats, such as, for example, Hyperscore source file, audio file, ring tones, ringback tones, hang-up tones or other sounds used by telecommunication devices and software, whether for free or for a particular charge. In turn, users whose compositions are frequently downloaded may be rewarded either through monetary incentives or through discounts and public acknowledgment. A licensing scheme may be employed to obtain permission and copyright rights from users to use and sell their compositions. FIG. 15 illustrates a homepage 1502 for a music space community at www.h-lounge.com. The homepage features a link 1504 for downloading Hyperscore software; a link 1506 that lists newly uploaded compositions which are available for download; an area 1508 that lists featured ringtone compositions uploaded by composers/authors 1514 with user ratings 1510; and a music review area 1512.

In one aspect of the invention, a user may choose to upload music directly from Hyperscore to the online community. An example screen 1602 for uploading a music composition file is shown in FIG. 16. From the integrated web interface, the user may name 1604 and categorize the music according to genre 1606, mood 1608, and other musical qualities. The user also is queried 1610 whether to allow other users to download the file, thereby sharing the motives and sketch windows with other users for listening, editing, modifying and re-uploading. Another query 1612 asks the user if the music file should also be sent to the user's cell phone.

When the music is uploaded, the file is entered into a queue and a conversion process takes place on the remote server in which the Hyperscore file format is converted to a format suitable for portable devices (e.g., MIDI, MP3), and a format that may be streamed via HTTP but not downloaded (i.e., flash video, shockwave). Appropriate truncation and/or compression for use on portable devices may also take place, creating an additional file for these purposes.

In yet another aspect of the invention, once the user has uploaded music to the online community, pertinent data is stored and adjusted in the remote server's database. Other users may play, rate, comment on, and download the music to portable devices. Statistics are kept on all of these actions and more, allowing for a number of ways in which the music may appear in filtered lists on the online community. Users may be awarded points for their actions in the online community, which can then be traded for various virtual or physical items or privileges. Abuse of this system is prevented from a programming perspective with the implementation of limits and algorithms that recognize nefarious behavior and also from a social perspective in the form of an online quiet room in which a user's privileges are temporarily revoked.

When a user chooses to download a file from the online community to a portable device, the web application may find and possibly modify the file most appropriate to the device. Depending on the user's device and related service, various applications may be used to deliver the file's contents via SOAP, HTTP, XML, etc. These applications may implement a queue to prevent bottlenecks in the download process. If the user elects to pay via a service connected with the device (i.e., cell phone carrier), then a double opt-in process is implemented in the communication with the portable device to prevent unwanted transactions.

Through uploading and sharing of melodies to a Hyperscore music space sharing community, the users may be enabled to download their friends' pieces, use motives from various pieces in their own pieces, and have more complex compositions. Blending between motives, rather than simply playing them at the same time, allows for almost unlimited creativity. Blending may mean simply fading the two melodies and motives together, or it may mean more complicated transformations, such as, for example, choosing the notes that have rhythmical correspondences to each other. The created melodies and motives may be uploaded to the server and resold by owner of the server with the user's permission. Alternatively, users may create their own musical stores from where other users may purchase the music, with a portion of the proceeds going to the server owners or maintainers.

In yet another embodiment of the invention, Hyperscore users may be enabled to collaborate and share whole files, parts of files, individual motives, strokes, notes or single actions synchronously, using real-time file sharing protocols or via a server. The software may locate other users on local networks or over IP, provide a synchronous ‘shared-space’ environment and thereby facilitate collaborative composition.

In yet another embodiment of the invention, music created by a user may be sent to different users by sending a link to a web server or downloading/editing the music directly on the user's computer. The friend receiving the music may not have Hyperscore installed, but there may be an option for him or her to download Hyperscore, to perform limited editing functions directly on the server or yet to listen to the music in a specially designed browser-based player.

The Hyperscore software may be used for pedagogical purposes, such as, for example, teaching children and adults the basics of music composition and encouraging them to create their own music. The results of those lessons may also be used as cell phone ring tones or as playback melodies for any other device or software. It will be apparent to one of skill in the art that the invention described herein may be extended in various ways, both functionally and business-wise.

While this invention has been particularly shown and described with reference to preferred embodiments thereof, it will be understood by those skilled in the art that various changes in form and details may be made therein without departing from the scope of the invention encompassed by the appended claims.

What is claimed is:

1. A method of distributing musical compositions, the method comprising:
receiving, at a server, composition data representing musical compositions created using graphical music creation software; and
transmitting, from the server to a user device, at least a portion of the composition data representing a selected musical composition.

2. The method of claim 1 wherein the graphical music creation software is based on Hyperscore software.

3. The method of claim 1 wherein receiving includes receiving the composition data in a first file format and further comprising converting the first file format to a second file format and transmitting includes transmitting the composition data for the selected musical composition in the second file format to the user device.

4. The method of claim 1 wherein receiving includes receiving the composition data in a first music notation format and further comprising converting the first music notation format to a second music notation format or audio format and transmitting includes transmitting the composition data in the second music notation format or audio format to the user device.

5. The method of claim i wherein the user device is a portable electronic device and transmitting includes transmitting the composition data from the server to the portable electronic device over a communications network.

6. The method of claim 5 wherein the portable electronic device is a cell phone, the composition data is in a ring tone compatible format and the communications network includes a wireless network.

7. The method of claim 1 wherein the user device is a personal computer, cell phone, VOIP phone, portable music player or portable digital assistant device.

8. The method of claim 1 wherein transmitting includes transmitting the composition data to the user device as an email attachment.

9. The method of claim 1 wherein transmitting includes transmitting a web link to the user device for retrieving the composition data from the server.

10. The method of claim 1 further comprising collecting a fee in association with transmitting the composition data to the user device.

11. The method of claim 1 wherein the selected musical composition is selected by a user associated with the user device.

12. The method of claim 1 wherein receiving includes receiving the composition data from plural musical composition authors through a web interface.

13. The method of claim 12 wherein the selected musical composition is selected by a user associated with the user device and further comprising collecting a fee for transmitting the composition data to the user device and sharing a portion of the collected fee with the musical composition author associated with the selected musical composition.

14. A method of distributing musical compositions, the method comprising:
providing a musical composition using graphical music creation software; and
uploading composition data representing the musical composition to a server.

15. The method of claim 14 wherein the graphical music creation software is based on Hyperscore software.

16. The method of claim 14 wherein uploading includes uploading the composition data in a ring tone compatible format.

17. The method of claim 14 further comprising collecting a fee in association with uploading the composition data to the server.

18. The method of claim 14 wherein providing includes downloading, from the server, composition data representing the musical composition and modifying the musical composition using the graphical music creation software, and uploading includes uploading the composition data representing the modified musical composition.

19. Apparatus for distributing musical compositions, the apparatus comprising:
means for receiving at a server composition data representing a musical composition created using graphical music creation software; and
means for transmitting the composition data from the server to a user device.

20. The apparatus of claim 19 wherein the graphical music creation software is based on Hyperscore software.

21. Apparatus for distributing musical compositions, the apparatus comprising;
means for providing a musical composition using graphical music creation software; and
means for uploading composition data representing the musical composition to a server.

22. The apparatus of claim 21 wherein the graphical music creation software is based on Hyperscore software.

23. In a graphical music creation environment in which notes are represented as elements in a graphical window along a temporal grid having grid lines, a method of note duration resizing comprising:
selecting one or more note elements;
clicking a selection handle associated with the selected note elements;
dragging the handle along a direction parallel to the temporal grid; and
releasing the handle when a desired duration for the selected note elements is reached along the temporal grid.

24. The method of claim 23 wherein the selected note elements are of equal duration.

25. The method of claim 23 wherein the selected note elements are of uneven duration.

26. The method of claim 23 wherein the selected note elements include rests.

27. The method of claim 23 wherein the beginning and/or the ending of the set of selected note elements are constrained to lie on a grid line of the temporal grid.

28. The method of claim 27 wherein the duration and onset of the selected note elements are constrained to lie on grid lines of the temporal grid.

29. The method of claim 27 wherein the duration and onset of the selected note elements are unconstrained to lie on grid lines of the temporal grid.

30. In a graphical music creation environment, a method of musical composition, the method comprising:
retrieving one or more musical composition motives from a music library, each musical composition motive representing a segment of music; and
creating a musical composition using the retrieved musical composition motives.

31. The method of claim 30 further comprising creating musical composition motives and storing the created musical composition motives in the music library.

32. The method of claim 30 wherein the music library resides on a web server.

33. A graphical music creation interface for defining a musical segment, the interface comprising:
a window having one or more measures and a temporal grid defining each measure with primary note divisions and each primary note division having secondary divisions, the window further having a pitch grid orthogonal to the temporal grid, the pitch grid having pitch divisions representing one or more note scales; and
note elements for placing on the window grids.

34. The graphical music creation interface of claim 33 wherein the temporal grid has a time signature of N/M where N is the number of primary note divisions and M is the note duration.

35. The graphical music creation interface of claim 33 wherein the pitch grid includes pitches at the tonic of the scale.

36. The graphical music creation interface of claim 33 wherein the pitch grid includes chromatic notes of the scale.

37. The graphical music creation interface of claim 33 wherein the pitch grid includes note pitches in a particular harmonic or chord progression.

38. The graphical music creation interface of claim 33 wherein the grids provide constraints on note beginning and ending related to temporal or pitch position.

39. The graphical music creation interface of claim 33 wherein the grids provide highlighting visual feedback for note placement on or off the grids.

40. In a graphical music creation environment, a method of musical composition, the method comprising:
assigning audio data to a musical composition motive;
displaying a shaped stroke in a graphical composition window, the stroke mapped to the musical composition motive;
segmenting the audio data into regions based on one or more audio features;
modulating the audio data by shifting the pitch of audio data in one or more regions based on position of the regions in corresponding portions of the stroke in the window.

41. The method of claim 40 wherein the audio features include constant pitch, changing pitch, transients and non-pitched.

42. The method of claim 40 further comprising displaying a second shaped stroke in the graphical window, the second shaped stroke mapped to a MIDI-based musical composition motive; and combining audio signals corresponding to the modulated audio data and the second shape stroke to provide an output audio signal.

43. The method of claim 40 wherein the pitch shifting is further based on harmonic content of the composition window.

44. Apparatus on a cell phone for musical composition, the apparatus comprising:
a display that displays one or more melody windows and/or one or more sketch windows;
a keypad having first keys for navigating among the windows and second keys for selecting and modifying elements within the windows to create and edit musical compositions.

45. The apparatus of claim 44 further comprising a microphone for recording audio signals to incorporate into the musical compositions.

46. A method of musical composition in a graphical music creation environment, the method comprising:
representing harmony, key or harmonic progression in a temporal harmony region of a composition window;
representing harmonic content of each harmony region including note structure that constrains the harmonic content in a harmonic content window; and
representing notes in the composition as constrained by the harmony regions.

47. The method of claim 46 further comprising modifying the harmony regions based on shape of a harmony line in the composition window.

48. The method of claim 46 further comprising modifying the harmony regions based on manipulation of the region duration using graphical handles.

49. The method of claim 46 further comprising modifying the pitch and temporal positions of the note structure of the regions.

50. The method of claim 46 further comprising modifying individual notes in the composition window to be outside the defined harmonic content.
